(19) United States
(12) Patent Application Publication
(10) Pub. No.: US 2009/0311169 A1
(43) Pub. Date: Dec. 17, 2009

(54) COMBUSTION SYNTHESIS AND DOPING OF OXIDE SEMICONDUCTORS

(76) Inventors: Krishnan Rajeshwar, Arlington, TX (US); Walter Morales, Arlington, TX (US); Norma Tacconi, Arlington, TX (US)

Correspondence Address: Parks Knowlton / UTA, 1117 Perimeter Center West, Atlanta, GA, 30338, US

(21) Appl. No.: 12/464,196

(22) Filed: May 12, 2009

Related U.S. Application Data
(60) Provisional application No. 61/052,492, filed on May 12, 2008.

(51) Int. Cl. C01G 41/02; C10L 1/22; C10L 1/24; C10L 1/10; C10L 1/18

(52) U.S. Cl. 423/606; 44/405; 44/417; 44/300; 44/322; 977/811

(57) ABSTRACT

The present invention relates to a method for producing inorganic oxide particles from a precursor material or mixture under combustion synthesis and compositions thereof. The combustion synthesis method is low-cost, low tech, and energy efficient. The combustion synthesized inorganic oxide particles of the method are smaller and exhibits a lower band gap than commercially available specimen of the same chemical composition.

### CROSS-REFERENCE TO RELATED APPLICATIONS

This application claims priority to U.S. Application No. 61/052,492, filed May 12, 2008, the entirety of which is herein incorporated by reference.

### STATEMENT REGARDING FEDERALLY SPONSORED RESEARCH OR DEVELOPMENT

The U.S. Government has in part a paid-up license in this invention and the right in limited circumstances to require the patent owner to license others on reasonable terms as provided for by the terms of Grant No. DE-FG02-04ER15623 awarded by the Department of Energy.

### BACKGROUND

The invention relates generally to the field of combustion synthesis and more particularly to methods of preparing nanosized particles of tungsten trioxide (“hereinafter WO₃”) using combustion synthesis and compositions thereof.

Inorganic oxides, such as titanium dioxide (TiO₂) and zinc oxide (ZnO) sparked significant interest as oxide semiconductors for solar photovoltaic, solar water photoelectrolysis and photocatalytic remediation applications. The main advantage of these semiconductors over other oxide semiconductors is that they are abundant in nature and environmentally benign. However, the combination of material properties required for the above applications is both stringent and daunting. For example, for solar photovoltaic devices, the active semiconductor material must have an optimal combination of optical (energy band gap, E_{g}, matching the solar spectral output) and electronic (large minority carrier lifetime and long diffusion length, low surface-state density) properties.

In solar water splitting applications, the semiconductor, in addition to the above-mentioned combination of optical and electronic characteristics, has to have conduction and valence band-edges in the aqueous medium appropriately juxtaposed relative to the redox levels for proton reduction and water oxidation, respectively. Rajeshwar, K. J. Appl Electrochem. 2007, 37, 765. The semiconductor also has to be chemically inert and photochemically stable over a wide pH range. Further, the semiconductor surface has to have high electrocatalytic activity to sustain high photocurrents and large H₂ generation rates.

Another example of the use of semiconductor photocatalysts for environmental remediation application requires that both highly reducing and oxidizing active species are generated at the semiconductor/medium interface. Thus, the semiconductor conduction band-edge has to lie at a reasonably negative potential while the valence band-edge should be located at very positive potentials. Only then will the photogenerated electrons and holes have sufficient energy for either directly converting the toxic substances to environmentally benign products or for generating mediator species (generally free radicals such as .OH) capable of oxidizing or reducing toxins. In addition, the photocatalyst must have all the combinations of optical, electronic, and surface characteristics discussed above.

Based on the foregoing, it is clear that no specific oxide semiconductor will have the optimal combination of properties for any particular application. TiO₂ has come close regarding its combination of properties for splitting water and its capability to oxidatively decompose toxic organic compounds; however, TiO₂ has a major drawback, which is its rather large optical ban gap (3.0-3.2 eV). As a result of the drawback, only a small fraction (˜4%) of the solar spectrum can be harnessed. Because of this disadvantage and its rather poor electronic properties, photocatalytic process efficiencies are very low.

The use of electron semiconductors such as Si in solid-state solar voltaics is known, however, Si is not stable when in contact with aqueous media, thus precluding its use in solar water splitting and environmental remediation applications.

In the ongoing search for a suitable oxide semiconductor for solar energy conversion, we found WO₃ to be a suitable oxide and that the general methods for preparing WO₃ were complex and expensive to accomplish.

To date, many methods have been used to prepare WO₃ in the form of powders, thin films or colloidal solutions, including sol-gel chemistry, thermal oxidation of tungsten, thermal or electron beam evaporation, sputtering, spray pyrolysis, pulsed laser deposition, chemical vapor deposition and electrodeposition. Watchenrenwong, A., et al., J. Electroanal. Chem. 2008, 612, 112. However, all of the present synthesis methodologies suffer from one or more following deficiencies such as requiring rather long reaction times ranging from several minutes to hours, being generally not energy efficient, and/or producing large particles. A significant advantage of WO₃ is its lower optical band gap of ˜2.7-2.8 eV relative to TiO₂ (˜3.0-3.2 eV)—a veritable workhorse in the photoelectrochemical water-splitting community—which results in a more substantial utilization of the solar spectrum.

Additionally, unlike other candidate semiconductors such as GaAs, InP, or CdTe, oxides such as WO₃ do not contain precious or toxic elements. They are also chemically inert and have exceptional chemical and photoelectrochemical stability in aqueous media over a very wide pH range. Butter, M. A., et al., Solid State Commun. 1976, 19, 1011 and Hodes, G. et al., Nature 1976, 260, 312.

The energy payback time associated with the semiconductor active material is an important parameter in a photovoltaic solar cell device. Thus lowering the energy requirements for the semiconductor synthesis step or making it more energy-efficient are critical toward making the overall device economics more competitive relative to other non-polluting energy options.

Presently, there is no energy efficient method of synthesizing inorganic oxide semiconductors such as WO₃ for photovoltaic or photocatyltic solar energy conversion. Thus, there is a need for a synthesis process that is low-cost, low technology and an energy efficient method that generates nanosized particles of WO₃.

The invention described herein overcomes one or more disadvantages described above, and provides a simple, reliable and environmentally friendly and economical method for synthesizing nanosized particle of WO₃. The nanosized particles produced by the combustion synthesis process are three to four times smaller and exhibit a lower band gap than commercial WO₃.

### SUMMARY OF THE INVENTION

In one aspect of the invention, as provided herein, is a method of synthesizing inorganic oxide particles comprising mixing a quantity of a fuel and an oxidizer precursor, dehydrating the fuel and oxidizer precursor mixture and igniting said dehydrated mixture under and inert gas atmosphere and pressure to form combustion synthesized inorganic oxide particles.

In another aspect of the invention, the optical band gap of the oxide semiconductor (i.e., shift its response toward the visible range of the electromagnetic spectrum) can be tuned in situ by doping the host semiconductor during the mixing of the fuel and oxidizer precursor mixture.

In another aspect of the invention, the combustion synthesis method provides a simple and versatile approach for incorporating targeted dopants into an oxide matrix by varying the chemical composition and fuel/oxidizer precursor ratio—also known as stoichiometric amounts.

In yet another aspect of the invention, the high process temperatures of the combustion synthesis are self sustained by the exothermicity of the combustion process and the only external energy input needed is the dehydration of the fuel/oxidizer precursor mixture and bringing it to ignition.

In another aspect of the invention, the resultant nanosized inorganic oxide particles have enhanced surface properties, including enhanced dye/colorant uptake relative to benchmark samples obtained from commercial sources.

In another aspect of the invention, the inorganic oxides produced from the combustion synthesis process are chemically inert and have exceptional chemical and photoelectrochemical stability in aqueous media over a very wide pH range and do not contain precious metals or toxic elements.

### BRIEF DESCRIPTION OF THE FIGURES

FIG. 1. depicts Tauc plots for three combustion-synthesized WO₃ samples (WO₃-G, WO₃-U and WO₃-T where G, U and T correspond to glycine, urea, and thiourea as fuel respectively in the combustion synthesis) and one reference commercial sample (B). The Tauc plots were generated from the diffuse reflectance data shown in the insert.

FIG. 2 depicts representative XRD spectra of three combustion-synthesized WO₃ samples and a WO₃ reference commercial sample.

FIG. 3 depicts a comparison of transmission electron micrographs for combustion-synthesized WO₃-G, WO₃-U and WO₃-T and commercial WO₃-B.

FIG. 4 compares high resolution XPS scans for three combustion synthesized WO₃ samples derived from glycine (G), urea (U) and thiourea (T) in the W4f core level region. Commercial WO₃ is included as comparison (WO₃-ref)

FIG. 5A depicts high resolution XPS scan of WO₃-U in the N1s core level region.

FIG. 5B depicts high resolution XPS scan of WO₃-T in the N1s core level region.

FIG. 6A depicts a bar plot showing the remaining methylene blue (MB) in solution equilibrated with 2 g/L of the respective four WO₃ sample and TiO₂ (Degussa P-25) in the dark for 30 min. Pictures of the corresponding dye solutions are inserted for each sample.

FIG. 6B depicts a comparison of the photocatylitic decoloration of methylene blue under visible light performed by the four WO₃ samples after adsorption equilibrium was achieved.

### DETAILED DESCRIPTION OF THE INVENTION

The invention, as provided with the claims, may be better understood by reference to the following detailed description. The description is meant to be read with reference to the figures contained herein. This detailed description relates to representative examples of the claimed subject matter for illustrative purposes, and is in no way meant to limit the scope of the invention as described. One or more embodiments discussed herein are merely illustrative of ways to make and use the invention, and do not limit the scope of the invention.

It must be noted that as used in the specification and appended claims, the singular forms “a,” “an,” and “the” include plural referents unless the context clearly dictates otherwise.

In the specification and claims which follow, reference will be made to a number or terms which shall be defined to have the following meanings:

Ranges are often expressed herein as from “about” one particular value, and/or to “about” another particular value. Similarly, when values are expressed as approximations, by use of the antecedent “about,” it will be understood that the particular value forms another embodiment.

The term “combustion synthesis” can be performed in a wide range of media; however in this invention, the process is confined to liquid mixtures that are dehydrated and brought to ignition and combustion in a furnace leading to a solid product (inorganic oxide semiconductors). An example of combustion synthesis involves the use of separate compounds for the oxidizer and the fuel. Thus, combustion synthesis is essentially a controlled explosion carried out in a synthetic context.

After mixing the compounds, the mixture is dehydrated and ignited at a temperature from about 100° C. to about 350° C. for a period of from about 3 to about 5 minutes to produce combustion synthesized inorganic oxide particles. In a second step, the combustion synthesized particles are ball-milled and then annealed at selected temperatures in the range of from about 400° C. to about 750° C. for about 20 to about 30 minutes. This subsequent step serves two purposes: 1) it enhances the crystallinity of the combustion synthesized product and; 2) it removes organic precursor residue from the synthesized oxide surface.

Exemplary fuels for the method include, but are not limited to glycine, urea, thiourea and the like.

A preferred oxidizer precursor for the method is a metal ion. More specifically, the metal ion oxide precursor is a peroxypolytungstic acid derivative and the like. In this invention a stoichiometric molar ratio of the precursor is used with one of the fuels.

Other than nanosize WO₃ particles, other inorganic oxide particles such as ZnO, TiO₂, Bi₂O₃, V₂O₅, BiVO₄ may also be suitable for this combustion synthesized method. Preferably, the nanosized particles are in the range of from about 5 nm to about 30 nm. Most preferably, the nanosized particles are in the range of from about 10 nm to about 15 nm.

Optical band gap values for the nanosized tungsten trioxide produced by combustion synthesis are from about 2.53 eV to about 2.56 eV, significantly smaller than the value (2.70 eV) for commercial samples

The invention is further described in connection with the following non-limiting examples.

### Preparative Example 1

### Preparation of WO₃ Inorganic Oxide Particles

A WO₃ precursor solution comprising of the peroxypolytungstic acid was prepared from hydrogen peroxide (15%) and tungsten powder according to a prior art procedure. Nanba, T., et al., J. Solid State Chem. 1991, 90, 47. Fresh precursor solution was used with a stoichiometric molar ratio of one of three different fuels, glycine, urea or thiourea. Then 10 mL of the precursor was placed in a platinum crucible along with an equivalent ratio of one of the fuels. Initial heating of the crucible containing precursor and fuel was performed in a hot plate. The crucible was then transferred to a furnace, preheated to 350° C. for a period of 3 to 5 minutes wherein the combustion synthesis reaction occurred. The resulting WO₃ inorganic oxide powder was ball-milled and then annealed at 450° C. for 30 minutes. The ball-milling and annealing step reduced the particle size and enhanced the crystallinity of the combustion synthesized product, especially in the case when the combustion duration is very short and less intense, and also removed organic precursor residues from the synthesized oxide surface.

The process was repeated using a fresh peroxypolytungstic acid precursor with each of the three fuels, glycine, urea or thiorurea. Samples obtained with glycine, urea or thiourea were designated WO₃-G, WO₃-U, and WO₃-T, respectively. A commercial sample of WO₃ was used as a benchmark reference (WO₃-B).

### Sample Characterization:

Physical characterization of the combustion synthesized samples were performed by UV visible diffuse reflectance data (Perkin Elmer Lambda 35 UV/VIS spectrophotometer), XRD patters (Siemens D-500 powder difractometer with CuK_{α} radiation), X-ray photoelectron spectroscopy (XPS, using a Perkin Elmer/Physical Electronics Model 5000C) and BET analysis (for specific surface areas).

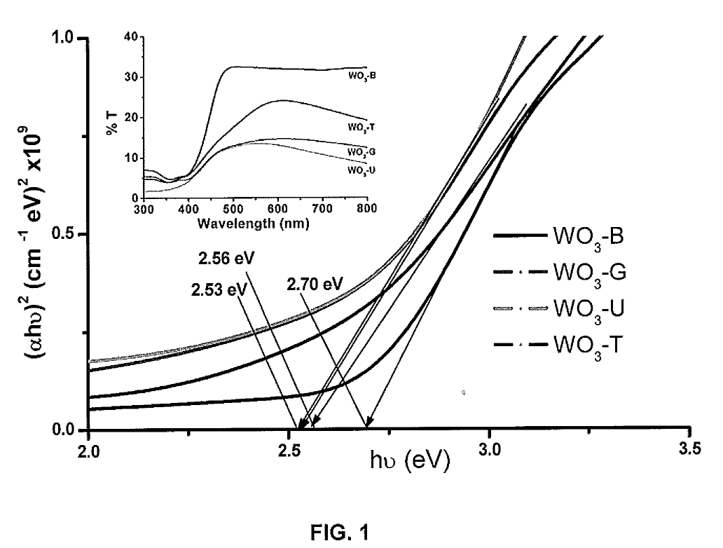

The optical response of the combustion-synthesized products are different from the commercial WO₃ sample as furnished by their visual appearance which are markedly darker than the yellow hue of the commercial WO₃ powder. This is quantitatively borne out by the diffuse reflectance UV-visible spectrophotometric data (FIG. 1). The spectra in FIG. 1 insert show stronger absorption at wavelengths longer than the band-edge cut-off for all the three combustion-synthesized samples (WO₃-G, WO₃-U, WO₃-T) relative to the benchmark (commercial) sample (WO₃-B). Tauc plots constructed from these data (FIG. 1) afford estimates of the optical band gap (2.53-2.56 eV) for WO₃-G, WO₃-U, WO₃-T, which are significantly “red-shifted” from the value (2.70 eV) for WO₃-B.

The origin of this optical response shift was further probed by X-ray powder diffraction (XRD) and X-ray photoelectron spectroscopy (XPS) (vide infra).

### X-Ray Diffraction (XRD):

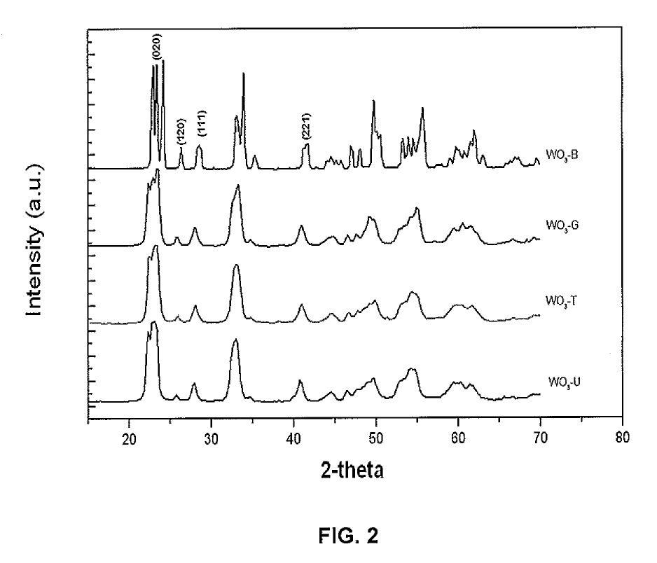

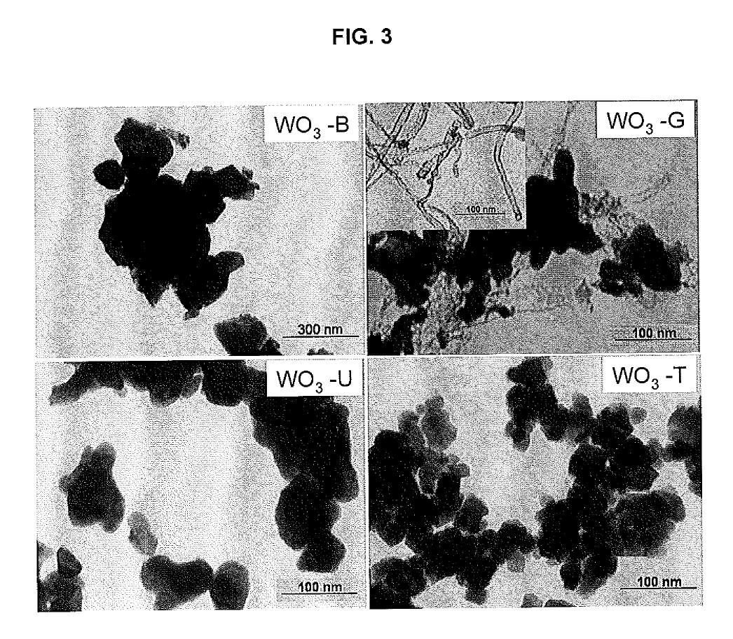

As depicted in FIG. 2, the diffraction lines of the three combustion samples are in accord with those of the commercial sample WO₃-B and assignable to a monoclinic unit cell structure although the diffraction peaks for the combustion synthesized oxides are significantly broadened than those in WO₃-B. The latter trend is diagnostic of both the diminution of particle size (see below) as well as the strain induced in the oxide lattice by foreign atom incorporation. Clearly, all the diffraction peaks for monoclinic WO₃ were faithfully reproduced in the WO₃-G, WO₃-U, WO₃-T samples relative to WO₃-B. Specifically peaks (111) and (020) located at 2θ in the 22-228 range were used to calculate for further characterization of the combustion-synthesized samples. Therefore, the crystallite sizes were estimated using XRD peaks (111) and (020), and applying Scherrer's equation to calculate an average value for each sample. Scherrer analyses of the XRD data afford estimates of the average WO₃ particle size: ˜59 nm for WO₃-B and in the ˜22, 16 and 12 nm range for WO₃-G, WO₃-U, and WO₃-T respectively as shown in Table 1. These estimates are mirrored in transmission electron microscopy (TEM) data which are contained in FIG. 3 for selected samples. Clearly the oxide particles in the combustion-synthesized samples are nanosized (a pre-requisite for good photocatalytic activity, see below) but importantly are finer in WO₃-U and WO₃-T relative to WO₃-B (and WO₃-G). This trend is also reflected in the N₂ surface area of the oxide samples (analyzed via the BET model) which (in m²/g) are: 1.74, 1.14, 5.84, and 10.1 for WO₃-B, WO₃-G, WO₃-U, and WO₃-T respectively.

TABLE 1
XRD Parameters for the various combustion-synthesized
WO₃ and the commercial benchmark

| Sample | 2θ | FWHM (2θ) | d-spacing [\acute{Å}] | crystallite size (nm) |
|---|---|---|---|---|
| WO₃-B | 28.695 | 0.12 | 3.108 | 59 ± 3 |
| WO₃-G | 27.993 | 0.30 | 3.185 | 22 ± 3 |
| WO₃-U | 27.804 | 0.42 | 3.206 | 16 ± 3 |
| WO₃-T | 28.070 | 0.54 | 3.176 | 12 ± 3 |

(Data obtained from FIG. 2)

### XPS:

X-ray photoelectron spectroscopy was performed after the samples were annealed at 450° C. for 30 minutes. Spectra showed the presence of the W, O and C in all samples. All combustion samples showed nitrogen while sulfur was found in very minor amounts only in the WO₃-T sample. Carbon was present not only as adventitious surface carbon because it appears at binding energies of 288.6 and 284.6 eV. The % atomic composition of each sample is presented in Table 2. Significantly, WO₃-G, WO₃-U and WO₃-T yielded also signals for extra carbon (WO₃-G), nitrogen (WO₃-G, WO₃-U, WO₃-T) and sulfur (WO₃-T) (see Table 2). Clearly, these elements originate from the organic feel precursors and the high temperatures generated during combustion facilitate their subsequent uptake by the oxide matrix. Importantly, combustion synthesis affords a simple and versatile approach for incorporating targeted dopants into an oxide matrix simply by varying the chemical composition of the fuel precursor as shown here.

TABLE 2
Atomic % composition of three combustion-synthesized WO₃
samples and comparison with a commercial specimen
(Data obtained from XPS surveys)

| W 4f | W | O | C | N | S |
|---|---|---|---|---|---|
| WO₃-B | 20.6 | 62.5 | 16.9 | — | — |
| WO₃-G | 19.5 | 60.0 | 19.2 | 1.3 | — |
| WO₃-U | 20.5 | 61.6 | 16.0 | 1.9 | — |
| WO₃-T | 18.3 | 55.4 | 17.4 | 8.4 | 0.5 |

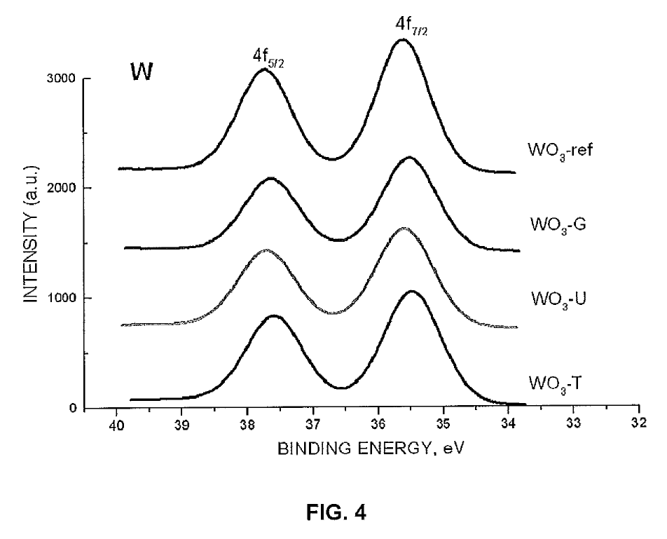

High-resolution XPS data showed the expected W and O binding energy signals along with adventitious carbon in all the WO₃ samples. The W spectral region with W4f_{7/2} and W4f_{5/2} peaks is presented in FIG. 4. The spin-orbit separation between these two peaks is ΔE=2.1 eV for the four samples, and is consistent with what is expected for WO₃. WO₃-B and WO₃-U coincide in both peak positions (located at 35.6 and 37.7 eV), while the other two samples are shifted by ˜0.5 eV (see Table 3). No peaks signaling tungsten nitride (35.8 eV) or W metal (31.9 eV) were observed. The peak positions in the WO₃-B and WO₃-J samples are consistent with reported values for WO₃.

TABLE 3
High-resolution XPS data at W4f core level
for three combustion-synthesized WO₃ samples
and comparison commercial specimen.

| Sample | Position (eV) | FWHM (2θ) | Area | W 4f |
|---|---|---|---|---|
| WO₃-B | 35.60 | 0.96 | 1259 | 4f_{7/2} |
| | 37.72 | 0.95 | 945 | 4f_{5/2} |
| WO₃-G | 35.51 | 0.99 | 898 | 4f_{7/2} |
| | 37.63 | 0.98 | 678 | 4f_{5/2} |
| WO₃-U | 35.59 | 1.0 | 1008 | 4f_{7/2} |
| | 37.70 | 1.9 | 754 | 4f_{5/2} |
| WO₃-T | 35.47 | 1.0 | 1136 | 4f_{7/2} |
| | 37.59 | 1.0 | 851 | 4f_{5/2} |

(Data from FIG. 3)

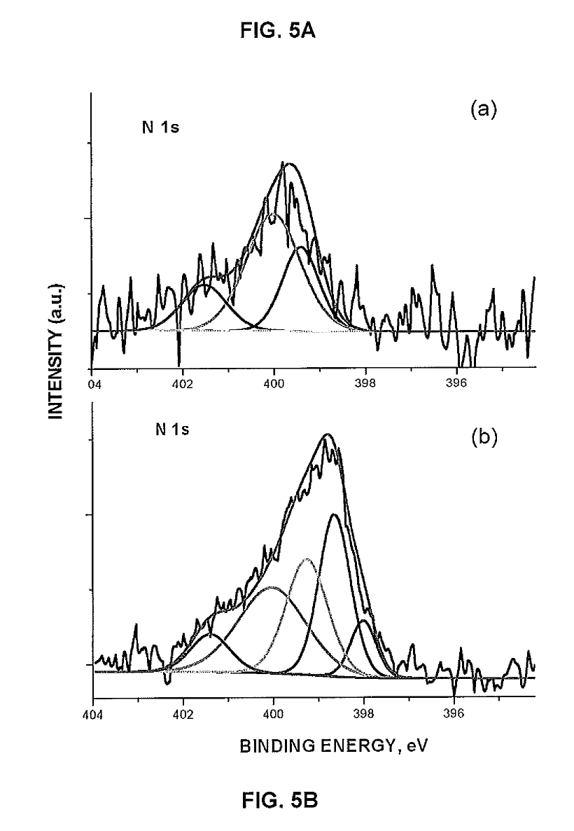

Representative high-resolution XPS data at the nitrogen 1s core level for WO₃-U and WO₃-T are contained in FIG. 5. Deconvolution of this spectral region is shown for the two samples in order to visualize the various components at the N1s core level. The peaks at 398.1 eV and 399.3 eV correspond to the formation of oxynitride, while a signal at 399.5 eV can be assigned to adsorbed nitrogen species such as hyponitrite. It might arise from a contribution of N bonded to C at 398.3 eV as well as residual amines at 399.5 eV.

### Adsorption and Photocatalytic Tests of the Combustion Synthesized Samples:

A photochemical reactor with an inner quartz compartment for the light source (750 W halogen-tungsten-lamp) equipped with a water circulating jacket was used for the following tests.

### Adsorption Test:

Methylene blue, a thiazine dye, was used as a probe of the surface and photocatalytic attributes of the combustion-synthesized WO₃ samples relative to the benchmark specimen. This dye is a popular probe in the heterogeneous photocatalysis community and its “dark” adsorption (on the oxide semiconductor surface) and its subsequent decoloration and decomposition can be monitored via its visible light absorption signature (at λₘₐₓ=660 nm).

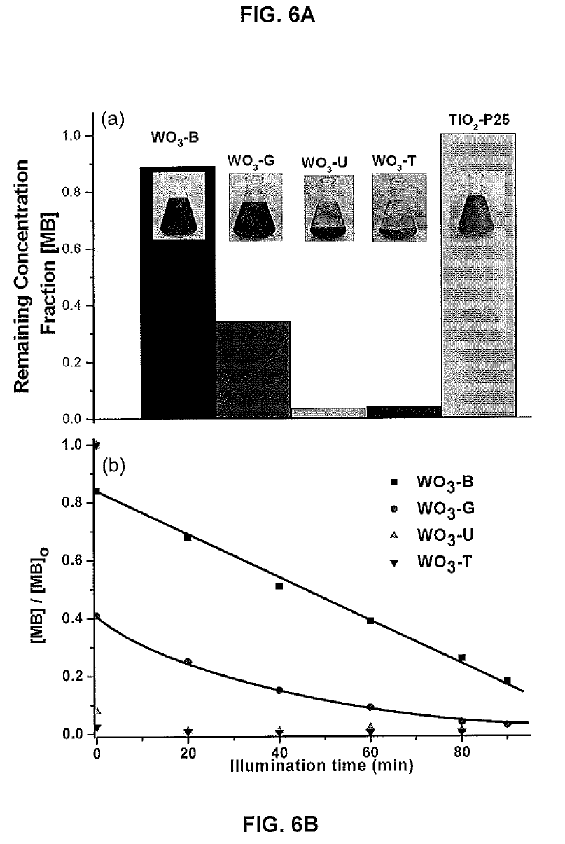

To perform the adsorption experiments, 250 mL of 50 μM methylene blue solution was added to 500 mg of each combustion synthesized powder. Under continuous stirring, the progression of the adsorption reaction in each batch was tested by taking aliquots and measuring spectrophotometrically (λ+660 nm) the solution decoloration as a function of time. Data is shown in FIG. 6a which compares the remaining amount of methylene blue after equilibration in the dark with the combustion synthesized WO₃ powders. Remarkably, ˜85% and ˜95% of the initial dye was removed from the aqueous solution by adsorption on the WO₃-U and WO₃-T surfaces after 30 mins. equilibration. Contrastingly ˜84% of the initial dye still remained in solution after this same equilibration period for WO₃-B (FIG. 6a). More than half of the initial dye has been adsorbed on WO₃-G (FIG. 6a) while a commercial Degussa P-25 TiO₂ sample—a popular photocatalyst, shows very little proclivity for dye adsorption even after 24 hours (FIG. 6a—right side). At least for the WO₃ samples, the above adsorption intensities are in accord with the N₂ surface area trends noted earlier. However, surface chemistry factors are also undoubtedly important as indicated by the fact that the N₂ surface area of Degussa P-25 TiO₂ is ˜50 m²/g; yet its adsorption affinity for the dye is negligible.

### Photocatalytic Test:

250 mL of methylene blue solution (50 μM) was placed in a double jacketed photochemical reactor. Then 500 mg (i.e., an oxide dose of 2 g/L) of selected combustion synthesized samples were added and air was bubbled through the mixture while stirring. The samples were kept in the dark for 30 minutes and then illuminated with visible light and the color of the solution was analyzed at regular time intervals. For that aim, centrifugation was used to separate any suspended WO₃ particles, and the subsequent temporal evolution of the dye concentration. The data in FIG. 6b must be taken to reflect the situation immediately after the adsorption period considered in FIG. 6a. Note that the photocatalytic decoloration of the dye for WO₃-B and WO₃-G follow zero- and first-order kinetics respectively when the light is turned on. The conversion extent for WO₃-U and WO₃-T is already almost complete thanks to extensive initial adsorption of the dye in the dark on the oxide surface. Also, the same protocol was followed with identical dye concentration as above, but with a lower combustion synthesized tungsten oxide dose (0.2 g/L see FIG. 6b).

While specific alternatives to steps of the invention have been described herein, additional alternatives not specifically disclosed but known in the art are intended to fall within the scope of the invention. Thus, it is understood that other applications and embodiments will be apparent to those skilled in the art upon reading the described embodiments herein and after consideration of the appended claims and drawings.

What is claimed is:

1. A method of synthesizing inorganic oxide particles which comprises:
mixing a quantity of a fuel and an oxidizer precursor;
dehydrating the fuel and oxidizer precursor mixture; and
igniting the mixture to form a powder comprising combustion-synthesized inorganic nanosized oxide particles.

2. The method of claim 1, further comprising the step of ball milling and annealing the resultant nanosized inorganic oxide particles/powder at a selected temperature for a time period of about 30 minutes.

3. The method of claim 2, wherein the ball-milling and annealing step is performed at a temperature of about 400° C. to about 600° C. for about 20 to about 30 minutes.

4. The method of claim 1, wherein the mixture comprises stoichiometric amounts of a fuel selected from the group consisting of glycine, urea and thiourea.

5. The method of claim 1, wherein the mixture comprises stoichiometric amounts of an oxidizer precursor, and the oxidizer precursor contains a metal ion.

6. The method of claim 1, wherein the oxidizer precursor is a peroxypolytungstic acid derivative.

7. The method of claim 1, wherein prior to igniting the fuel and oxidizer precursor the amount of fuel and oxidizer precursor are selected to provide doped inorganic oxide nanoparticles.

8. The method of claim 1, wherein the size of the particles/powder range from about 10 nm to about 22 nm.

9. The method of claim 1, wherein the inorganic oxide particles are WO₃.

10. The method of claim 1, wherein the particles have semiconductive properties.

11. The method of claim 1, wherein the inorganic oxide particles have an optical band gap of from about 2.53 eV to about 2.56 eV.

12. A composition of a fuel and an oxidizer precursor prepared for subsequent combustion synthesis to generate an oxide semiconductor.

13. The composition of claim 12, wherein the composition comprises stoichiometric amounts of a fuel selected from the group consisting of glycine, urea and thiourea.

14. The composition of claim 12, wherein the composition comprises stoichiometric amounts of an oxidizer precursor and the oxidizer precursor contains a metal ion.

15. The composition of claim 12, wherein the oxidizer precursor comprises a peroxypolytungstic acid derivative.

16. A photovoltaic device containing the composition of claim 12.

17. A photocatalytic device containing the composition of claim 12.
